(19) United States
(12) Patent Application Publication
(10) Pub. No.: US 2009/0179633 A1
(43) Pub. Date: Jul. 16, 2009

(54) SELECTOR SWITCH

(75) Inventor: Fabio Donadelli, Sao Paulo (BR)

Correspondence Address: VOLPE AND KOENIG, P.C., UNITED PLAZA, SUITE 1600, 30 SOUTH 17TH STREET, PHILADELPHIA, PA, 19103, US

(73) Assignee: EMICOL ELETRO ELETRONICA S.A., Sao Paulo (BR)

(21) Appl. No.: 12/271,327

(22) Filed: Nov. 14, 2008

(30) Foreign Application Priority Data
Nov. 21, 2007 (BR) PI0705299-5

(51) Int. Cl. G01D 5/12; H01H 3/40; H01H 19/00

(52) U.S. Cl. 324/207.25; 200/501; 200/336

(57) ABSTRACT

Improvement on selector switch. The present invention refers to an improvement on a selector switch mainly used in the control of electro-electronic equipment. Said improvement consists of the introduction of magnetic elements on the switch to allow the performance of movement in both directions, the control of electro-electronic equipment, and the reduction of the number of components, which significantly reduces its wear, offering more reliability to the finished product and the possibility to identify the position of the switch when the user turns it on, even if it is moved when it is off.

### FIELD OF INVENTION

The present invention refers to an improvement on a selector switch used for the control of electro-electronic equipment. Said improvement comprises the introduction of magnetic elements in the switch in order to allow back and forth movement and control of the electro-electronic equipment.

### BACKGROUND

In general, electro-electronic equipment such as washing machines, dishwashers and others use a type of electromechanical timer, which, through the action of a step motor and a sequence of tracks, creates several time intervals and control circuits that activate the different features of said piece of equipment.

This kind of solution is usually expensive, due to the use of a number of parts, which, over time, suffer wear and, thus, are likely to have loose contacts and even cause short circuits In cases of total rupture.

Industrial machines such as lathes and others commonly use a control element called encoder. The encoder is a transducer that converts angular or linear movement in a series of electric digital pulses. These generated pulses can be used to determine speed, acceleration rate, distance, rotation, position or direction, and their main applications are:

NC and CNC machine tool axles;

robot axles

speed and position control of electric motors;

position of satellite dishes, telescopes and radars;

rotary tables; and

direct or indirect measurements of the above mentioned.

The encoder has a reading system that comprises a disc (rotary encoder), formed by transparent and opaque alternated radial windows. The disc is illuminated vertically by an infrared light source, and the images of the transparent windows are projected on the receiver. The receiver converts these light widows into electric pulses. The encoders can be classified as incremental or absolute encoders.

The incremental encoder usually supplies two square pulses delayed in 90° that are usually named channel A and channel B. The reading from one channel provides only the speed; while the reading of the two channels suplies the direction of the movement. Another signal called Z or zero is also available through a parallel track and it gives the absolute “zero” position of the encoder.

The operational principle of an absolute encoder and an incremental encoder is very similar, that is, both use the principle of opaque and transparent windows that interrupt a light beam and transform light pulses into electric pulses.

The absolute encoder has an important differential regarding the incremental encoder: the position of the incremental encoder is given by pulses from zero pulse, while the position of the absolute encoder is determined by a code reading and this code is unique for each position of its course; consequently, absolute encoders do not lose the real position in a power failure (even if displaced). When power returns to the system, the position is updated and made available for the same (due to the code recorded on the encoder disc). It is not necessary to go to position zero to find its location as is the case with the incremental encoder.

The encoder is very useful for equipment that uses movements around an axle, such as lathes and others, but it behaves passively, only indicating relative operating positions and, by a supplementary track, indicating the system start-up point (zero position).

The applicant has already made an improvement on a device of this kind, using the optical method, but it was found that, in some cases, in aggressive environments or environments with dust in suspension, the device can fail.

### SUMMARY

The purpose of the present invention is to use the encoder reading principle on an active device, such as a control switch, however without an encoder disc to determine the position, instead, a magnetic sensor will be used.

Additionally, the present invention allows the switch to be operated clockwise or counterclockwise, offering new functions for said switch without increase of costs.

### BRIEF DESCRIPTION OF THE DRAWINGS

The present invention will be better understood in light of the attached figures, given here merely as examples but not limiting the scope of the present invention:

FIG. 1—side view of the switch FIG. 2—cross section of a side of the switch FIG. 3—exploded top view; and FIG. 4—exploded lower view

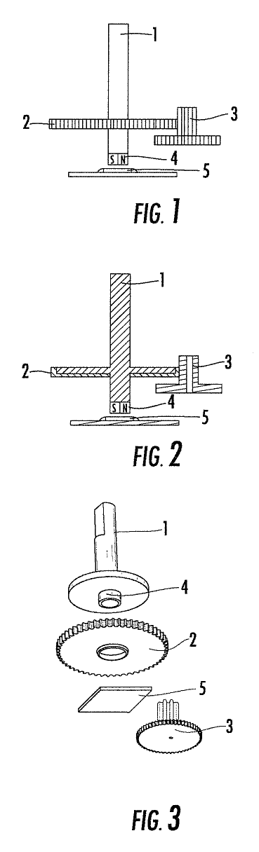

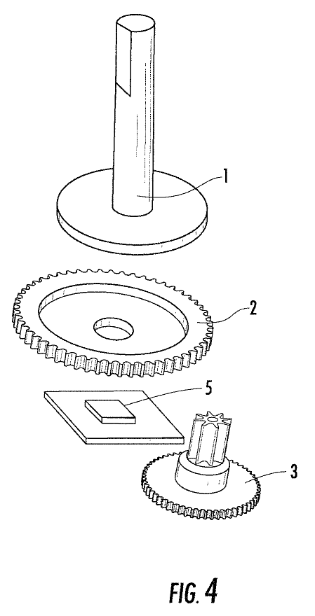

### DETAILED DESCRIPTION OF THE PREFERRED EMBODIMENTS

The present invention is composed of a reduced number of components, but has a wide range of movements.

The magnetic switch (A) comprises an actuating axle (1) coupled to a magnet (4) which has a support on its lower portion , where a gear system rests (2). This gear system is coupled to an outlet gear (3) from a reduction box (not shown).

The magnet (4) spins with said actuating axle, which is in a cavity, where the magnetic field sensor (5) is placed. The magnet (4) has an alignment of poles in such a manner that when it spins on the magnetic field sensor (5), it changes the near magnetic field, thus allowing the detection of the relative position between the magnet (4) and the sensor (5). The position between the magnet (4) and the sensor (5) will generate signals that correspond to the incremental or absolute encoder signals, according to the configuration of the sensor (5).

The operation of the magnetic switch (A) is simple, and when configured as an absolute encoder, once the position of the switch (A) is read through the signals generated by the magnet sensor (5), the switch can be turned in any direction, clockwise or counterclockwise, to activate the commands the user desires.

When the control system deems necessary, the movement of the switch (A), the gear system and the reduction box (2,3) will be actuated until the switch (A) reaches the position required by the control system.

If configured as an incremental encoder, the switch (A) starts by finding the zero position by the rotation of the magnet rotation (4) produced by the gear system (2,3) and by the reduction box. Once the position is found by the magnet rotation (4) and the magnetic sensor (5), the circuit of switch (A) is initiated and the switch receives a command from the circuit, actuating the set of gears (2, 3) until the magnet (4) and thus, its axle (1) are placed in position for the start of the operation.

Once in this position the switch (A) can be turned in any direction, clockwise or counterclockwise, to activate the commands the user desires.

When the control system deems necessary the movement of the switch (A), the gear system and the reduction box (2,3) will be actuated until the switch (A) reaches the position required by the control system.

Optionally, the gear system (2,3) and the reduction box, in both cases, can present some resistance to activation by the user to provide a more precise operation of the switch (A).

The great advantage of the present invention in comparison with mechanical selector switches, is its reduced number of components, which significantly reduces its wear, offering more reliability to the final product and the possibility to identify the position of the switch when the user turns it on, even if it is moved when it is off without the need of spinning it to find the zero position.

1. Improvement on selector switch of the magnetic type switch characterized by the fact that the switch comprises an actuating axle coupled to a magnet which has a support in its lower portion, where a gear system rests, said system being connected to a outlet gear of a reduction box, said switch possessing in its cavity a magnetic field sensor.

2. Improvement, according to claim 1, characterized by the fact that the magnet has alignment of its poles in such a way that, when it spins on a magnetic field sensor it changes the magnetic field near it and allows the sensor to determine the relative position between the magnet and the sensor.

3. Improvement, according to claim 1, characterized by the fact that the gear system and the reduction box offer resistance to activation by the user.
